(19) United States
(12) Patent Application Publication
(10) Pub. No.: US 2016/0083288 A1
(43) Pub. Date: Mar. 24, 2016

(54) GLASS FOR CHEMICAL STRENGTHENING, CHEMICALLY STRENGTHENED GLASS, AND METHOD FOR PRODUCING CHEMICALLY STRENGTHENED GLASS

(71) Applicant: Asahi Glass Company, Limited, Chiyoda-ku (JP)

(72) Inventors: Junichiro KASE, Tokyo (JP); Shuichi AKADA, Tokyo (JP); Jun SASAI, Tokyo (JP); Shusaku AKIBA, Tokyo (JP)

(73) Assignee: Asahi Glass Company, Limited, Chiyoda-ku (JP)

(21) Appl. No.: 14/959,116

(22) Filed: Dec. 4, 2015

Related U.S. Application Data
(63) Continuation of application No. PCT/JP2014/063890, filed on May 26, 2014.

(30) Foreign Application Priority Data
Jun. 6, 2013 (JP) 2013-119906
Dec. 13, 2013 (JP) 2013-258469

(51) Int. Cl. C03C 3/087; C03C 23/00; C03B 18/14; C03C 21/00

(52) U.S. Cl. CPC C03C 3/087; C03C 21/002; C03C 23/008; C03B 18/14

(57) ABSTRACT

A glass for chemical strengthening is a glass plate. The glass plate includes, as represented by mass percentage based on the following oxides, 65 to 72% of SiO₂, 3.4 to 8.6% of Al₂O₃, 3.3 to 6% of MgO, 6.5 to 9% of CaO, 13 to 16% of Na₂O, 0 to 1% of K₂O, 0 to 0.2% of TiO₂, 0.01 to 0.15% of Fe₂O₃ and 0.02 to 0.4% of SO₃. In the glass plate, (Na₂O+K₂O)/Al₂O₃ is 1.8 to 5.

### TECHNICAL FIELD

The present invention relates to a glass for chemical strengthening preferred for use as a blank glass for a cover glass and a touch sensor glass of touch panel displays provided in information devices such as tablet PCs, note PCs, smartphones, and electronic book readers, a cover glass of liquid crystal televisions, PC monitors and the like, a cover glass for solar cells, a chemically strengthened glass used for double-glazing to be used for building and house windows, and the like. The present invention also relates to a chemically strengthened glass that uses the glass for chemical strengthening, and a method for producing the chemically strengthened glass.

### BACKGROUND ART

Information devices equipped with touch panel displays have become mainstream, as in devices such as tablet PCs, smartphones, and electronic book readers. A touch panel display is structured to include a display glass substrate, and a touch sensor glass and cover glass, which are laminated on the substrate. An integral unit of touch sensor glass and cover glass, which is called OGS (One Glass Solution), is also available.

There is a demand for a thinner and stronger touch sensor glass, cover glass, and OGS glass, and a chemically strengthened glass subjected to an ion-exchange chemical strengthening process has been used for this purpose.

The strength characteristics of such chemically strengthened glass are typically represented by surface compressive stress (CS; compressive stress), and depth of compressive stress layer (DOL; Depth of layer). A chemical strengthening process of a common soda-lime glass, as a blank glass, typically produces a chemically strengthened glass having a CS of 500 to 600 MPa and a DOL of 6 to 10 μm.

An aluminosilicate glass of a composition suited for ion exchange has been proposed to improve strength. A chemical strengthening process of an aluminosilicate glass, as a blank glass, produces a chemically strengthened glass having a CS of 700 to 850 MPa and a DOL of 20 to 100 μm.

A conductive film such as ITO is deposited on one side or both sides of a touch sensor glass or an OGS glass after the chemical strengthening process. For efficiency of the chemical strengthening process or the deposition process, it is effective to perform these processes on larger glass plates, and cut the processed glass plate into individual plates of product shapes.

As described above, in the case of the chemically strengthened glass of a conventional soda-lime glass, since the values of the CS and DOL is not so large, the cutting of the chemically strengthened glass is possible after the chemical strengthening process, and this kind of glass is suited for producing individual glasses by cutting.

However, it has been difficult to improve the CS of the chemically strengthened glass of the conventional soda-lime glass to the level of strength needed to meet the current demand. In order to meet such a demand, there is a proposed chemical strengthening process method that can improve the glass strength of a chemically strengthened glass of the soda-lime glass while allowing the glass to be cut after the chemical strengthening process (see, for example PTL 1).

On the other hand, a chemically strengthened glass of the aluminosilicate glass generally has large CS and DOL values, and is not suited for cutting after the chemical strengthening process. The glass thus requires a chemical strengthening process for every glass plate that has been cut into a product shape, and this is one factor of increasing the manufacturing cost. As a countermeasure, it is conventional to intentionally decrease the DOL by reducing the chemical strengthening process time, and produce a chemically strengthened glass of an aluminosilicate glass that can be cut after the chemical strengthening process (see, for example, PTL 2).

### CITATION LIST

### Patent Literature

PTL 1: WO 2013/47676 A1
PTL 2: JP-A-2013-14512

### SUMMARY OF INVENTION

### Technical Problem

The method disclosed in PTL 1 requires a two-step chemical strengthening process under strict control, and the first and second processes use nitrates of different compositions, and the process temperatures are different. The processes thus require two strengthening process tanks. The method is thus more costly than conventional methods, and fails to take advantage of the low cost of soda-lime glass. The two chemical strengthening processes also increase the extent of warping in the strengthened glass. In order to avoid this, the method requires an additional step of removing the surface layer which would undergo changes in strength characteristics under the effect of tin entry or the like beforehand.

PTL 2 discloses a stress range that allows for cutting after a chemical strengthening process. The value represented by compressive stress function F shown in PTL 2 is known as center tensile stress (internal tensile stress; CT: Center tension), and is known to have the following relation:

CT=CS·DOL/(t−2DOL) (1),

where t is a thickness of a glass plate.

However, the stress range defined in PTL 2 is no different from the stress that results from a general chemical strengthening process of a common soda-lime glass, and does not provide any index of strength improvement for common soda-lime glass.

Aluminosilicate glass contains more expensive components than those contained in a common soda-lime glass, and requires melting and forming at higher temperatures than temperatures used for a common soda-lime glass. Thus, there is a problem that the manufacturing cost is high, and there is no advantage in using aluminosilicate glass when the strength level is the same.

In the present invention, an object thereof is to provide a glass for chemical strengthening that can be cut after a chemical strengthening process (post cutting), and can have improved strength over conventional soda-lime glass even when a conventional chemical strengthening process is applied, and also provide a chemically strengthened glass using such a glass, and a method for producing the chemically strengthened glass.

### Solution to Problem

The present inventors found a glass having a specific composition that can be cut after a chemical strengthening process, and that can have improved strength over conventional soda-lime glass even when a conventional chemical strengthening process is applied. The present invention was completed on the basis of these findings.

That is, the followings are provided.

1. A glass for chemical strengthening, which is a glass plate comprising, as represented by mass percentage based on the following oxides, 65 to 72% of SiO₂, 3.4 to 8.6% of Al₂O₃, 3.3 to 6% of MgO, 6.5 to 9% of CaO, 13 to 16% of Na₂O, 0 to 1% of K₂O, 0 to 0.2% of TiO₂, 0.01 to 0.15% of Fe₂O₃ and 0.02 to 0.4% of SO₃, wherein (Na₂O+K₂O)/Al₂O₃ is 1.8 to 5.

2. The glass for chemical strengthening according to the above item 1, wherein the glass plate has a thickness of 0.1 mm or more and 1.5 mm or less.

3. The glass for chemical strengthening according to the above item 1 or 2, which comprises, as represented by mass percentage based on the following oxides, 0 to 0.5% of SrO, 0 to 0.5% of BaO and 0 to 1% of ZrO₂, and does not substantially comprise B₂O₃.

4. The glass for chemical strengthening according to any one of the above items 1 to 3, wherein the glass plate is formed by a float method.

5. A chemically strengthened glass obtained by conducting a chemical strengthening process of the glass for chemical strengthening as described in any one of the above items 1 to 4.

6. The chemically strengthened glass according to the above item 5, which has a surface compressive stress (CS) of 600 MPa or more, a compressive stress layer depth (DOL) of 5 μm or more and 30 μm or less, and a center tensile stress (CT) of 30 MPa or less,

wherein the center tensile stress (CT) is calculated according to the following formula (1):

CT=CS·DOL/(t−2DOL) (1),

where t is a thickness of the glass plate.

7. The chemically strengthened glass according to the above item 6, wherein the surface compressive stress is 650 MPa or more, and the compressive stress layer depth is 7 μm or more and 20 μm or less.

8. A method for producing a chemically strengthened glass, the method comprising a chemical strengthening step of subjecting the glass for chemical strengthening as described in any one of the above items 1 to 4 to an ion exchange process.

9. The method according to the above item 8, wherein:

the glass for chemical strengthening is formed by a float method, and has a bottom surface to contact with a molten metal during forming, and a top surface opposite the bottom surface, and

the method comprises a step of subjecting the top surface to a dealkylation treatment with an acidic gas before the chemical strengthening step.

### Advantageous Effects of Invention

The glass for chemical strengthening in the present invention has a specific composition, specifically specific contents of Al₂O₃ and Na₂O, and a specific range of (Na₂O+K₂O)/Al₂O₃. The glass can be used to provide a chemically strengthened glass that can effectively improve its CS value after a chemical strengthening process, and that can be cut after the chemical strengthening process.

### BRIEF DESCRIPTION OF DRAWINGS

FIG. 1 is a diagram representing the correlation between CS×DOL and warping (Example 4).

### DESCRIPTION OF EMBODIMENTS

A glass for chemical strengthening in the present invention, and a chemically strengthened glass after a chemical strengthening process of the glass for chemical strengthening will collectively be referred to as a glass in the present invention.

An embodiment in the present invention is described below. The glass for chemical strengthening in the embodiment contains, as represented by mass percentage based on the following oxides, 65 to 72% of SiO₂, 3.4 to 8.6% of Al₂O₃, 3.3 to 6% of MgO, 6.5 to 9% of CaO, 13 to 16% of Na₂O, 0 to 1% of K₂O, 0 to 0.2% of TiO₂, 0.01 to 0.15% of Fe₂O₃, and 0.02 to 0.4% of SO₃, in which (Na₂O+K₂O)/Al₂O₃ is 1.8 to 5.

The following describes the reasons for limiting the foregoing glass composition range in the glass for chemical strengthening in the embodiment.

SiO₂ is known as a component that forms the network structure of a glass microstructure, and represents a main component of glass. The content of SiO₂ is 65% or more, preferably 66% or more, more preferably 66.5% or more, further preferably 67% or more. The content of SiO₂ is 72% or less, preferably 71.5% or less, more preferably 71% or less. The content of SiO₂ of 65% or more is preferable in terms of glass stability, and weather resistance. The content of SiO₂ of 72% or less is preferable in terms of meltability and formability.

Al₂O₃ has the effect to improve the ion exchange performance of chemical strengthening, particularly has the large effect to improve the CS. Al₂O₃ is also known as a component that improves the weather resistance of glass. This component also has the effect to suppress entry of tin from the bottom surface during float forming. Al₂O₃ also has the effect to promote dealkylation when a SO₂ process is conducted.

The content of Al₂O₃ is 3.4% or more, preferably 3.8% or more, more preferably 4.2% or more. The content of Al₂O₃ is 8.6% or less, more preferably 8% or less, further preferably 7.5% or less, particularly preferably 7% or less. When the content of Al₂O₃ is 3.4% or more, a desirable CS value can be obtained through ion exchange. It is also possible to obtain the effect to suppress tin entry, the effect to stabilize water content changes, and the effect to promote dealkylation. On the other hand, when the content of Al₂O₃ is 8.6% or less, the devitrification temperature does not greatly increase even when the glass has high viscosity, and this is preferable in terms of melting and forming in a soda-lime glass production line.

MgO is a component that stabilizes the glass, and is essential. The content of MgO is 3.3% or more, preferably 3.6% or more, more preferably 3.9% or more. The content of MgO is 6% or less, preferably 5.7% or less, more preferably 5.4% or less. When the content of MgO is 3.3% or more, meltability becomes desirable at high temperatures, and devitrification becomes unlikely to occur. On the other hand, when the content of MgO is 6% or less, devitrification remains unlikely, and a sufficient ion-exchange rate can be obtained.

CaO is a component that stabilizes the glass, and is essential. The content of CaO is 6.5% or more, preferably 6.7% or more, more preferably 6.9% or more. The content of CaO is 9% or less, preferably 8.5% or less, more preferably 8.2% or less. When the content of CaO is 6.5% or more, meltability becomes desirable at high temperatures, and devitrification becomes unlikely to occur. On the other hand, when the content of CaO is 9% or less, a sufficient ion-exchange rate can be obtained, and the desirable DOL can be obtained.

Na₂O is an essential component that forms a surface compressive stress layer through ion exchange, and has the effect to increase DOL. Na₂O is also a component that lowers the high-temperature viscosity and devitrification temperature of the glass to improve the meltability and formability of the glass. Na₂O is a component that produces a non bridge oxygen (NBO), and makes the fluctuations of chemical strength characteristics smaller in response to water content changes in glass.

The content of Na₂O is 13% or more, preferably 13.4% or more, more preferably 13.8% or more. The content of Na₂O is 16% or less, preferably 15.6% or less, more preferably 15.2% or less. When the content of Na₂O is 13% or more, a desirable surface compressive stress layer can be formed through ion exchange, and fluctuations in response to water content changes can be suppressed. On the other hand, when the content of Na₂O is 16% or less, the sufficient weather resistance can be obtained, and it becomes possible to reduce the amount of tin entry from the bottom surface during float forming, and make the glass less likely to warp after the chemical strengthening process.

K₂O has the effect to increase the ion-exchange rate and DOL. Because K₂O is a component that increases the non bridge oxygen, this component may be contained in 1% or less. When the content of K₂O is 1% or less, the DOL does not become excessively large, and a sufficient CS can be obtained. When K₂O is contained, in the content is preferably 1% or less, more preferably 0.8% or less, further preferably 0.6% or less. Because small amounts of K₂O have the effect to suppress entry of tin from the bottom surface during float forming, it is preferable to contain K₂O when float forming is conducted. In this case, the content of K₂O is preferably 0.05% or more, more preferably 0.1% or more.

TiO₂ is abundant in natural raw materials, and is known to be a source of yellow color. The content of TiO₂ is 0.2% or less, preferably 0.13% or less, more preferably 0.1% or less. The glass becomes yellowish when the content of TiO₂ exceeds 0.2%.

Fe₂O₃ is not an essential component, and exists in a wide range of places such as in nature and production lines. It is accordingly very difficult to make the content of this component zero. It is conventional that Fe₂O₃ which is an oxidized state becomes a cause of the yellow color, and that FeO which is a reduced state becomes a cause of the blue color. It is conventional that glass turns green in the balance between these states.

When the glass of the embodiment is used for display, window glass, and solar applications, it is not desirable to have a dark color. The total iron content (total Fe) is thus preferably 0.15% or less, more preferably 0.13% or less, further preferably 0.11% or less in terms of Fe₂O₃.

SO₃ is a refining agent for glass melting. Generally, the content of SO₃ in glass is not higher than a half of the amount supplied from the raw material. The content of SO₃ in glass is 0.02% or more, preferably 0.05% or more, more preferably 0.1% or more. The content of SO₃ is 0.4% or less, preferably 0.35% or less, more preferably 0.3% or less. When the content of SO₃ is 0.02% or more, it is possible to sufficiently refine the glass, and reduce blister defects. On the other hand, when the content of SO₃ is 0.4% or less, defects due to the generated sodium sulfate in glass can be reduced.

The present inventors found that the cuttability of a thin plate glass chemically strengthened under various conditions is limited by the CT value in cutting the glass with a wheel cutter. Specifically, it was found that, by increasing the CS value, the glass strength can be improved while maintaining cuttability, provided that the DOL value is sufficiently low. When the thickness t of a glass plate is sufficiently larger than DOL, the foregoing equation (1) can be approximated by the following formula (2).

CT=CS·DOL/t (2)

While Al₂O₃ has the effect to improve CS, Na₂O has the effect to increase DOL and also lower CS. K₂O has the effect to increase the ion-exchange rate and DOL.

It is thus possible to improve CS value, and enable the glass to be cut after the chemical strengthening process when the glass contains Al₂O₃, Na₂O, and K₂O in specific proportions. The ratio (Na₂O+K₂O)/Al₂O₃ is 5 or less, preferably 4.5 or less, more preferably 4 or less.

Al₂O₃ is a component that increases high-temperature viscosity and devitrification temperature, whereas Na₂O and K₂O are components that lower these. When (Na₂O+K₂O)/Al₂O₃ is less than 1.8, the high-temperature viscosity and the devitrification temperature increase. There is also a possibility of making the DOL unnecessarily small. While Al₂O₃ is a component that reduces the non bridge oxygen, Na₂O and K₂O are components that increase the non bridge oxygen. The preferred ratio, (Na₂O+K₂O)/Al₂O₃, for stable glass production, and for maintaining the DOL necessary to improve strength, and obtaining chemical strength characteristics that are stable against water content changes is 1.8 or more, preferably 2.2 or more, more preferably 2.4 or more.

In a chemical strengthening process of glasses of the same base composition with different water contents, the present inventors also found that the CS value decreases with increase of water content, and that the DOL value decreases only slightly with increase of water content and is not heavily dependent on water content. The present inventors also found that the CS changes in response to water content changes become smaller as the content of Na₂O or K₂O in the glass increases. This is considered to be due to the increased non bridge oxygen in glass. On the other hand, the non bridge oxygen in glass decreases as the content of Al₂O₃ increases. In a glass containing 3.4% or more of Al₂O₃, the ratio, (Na₂O+K₂O)/Al₂O₃, is preferably 1.8 or more in order to obtain chemical strength characteristics that remain stable regardless of the water content.

The present inventors investigated the relationship between the glass composition of a glass formed by using a float method, and amounts of tin entry on the bottom surface. It was found as a result that the content of Al₂O₃ in glass affects tin entry, and that increased amounts of the Al₂O₃ component have the effect to suppress tin entry. It was also found that the alkali component, i.e., the content of Na₂O also affects tin entry, and has the effect to encourage tin entry. It is therefore possible to suppress tin entry in float forming and reduce glass warping after chemical strengthening by maintaining the value of Na₂O/Al₂O₃ in an appropriate range.

By focusing on the components Al₂O₃ and Na₂O, these have the opposite effects on CS and DOL, high-temperature viscosity, devitrification temperature, and amounts of tin entry from the bottom surface. It is preferable to contain Al₂O₃ and Na₂O in specific proportions, and Na₂O/Al₂O₃ is preferably 5 or less, more preferably 4.5 or less, further preferably 4 or less to improve the CS value and reduce amounts of tin entry. In order to maintain the DOL necessary to improve strength, and suppress increase of high-temperature viscosity and devitrification temperature, Na₂O/Al₂O₃ is preferably 1.8 or more, preferably 2 or more, more preferably 2.4 or more.

Components such as chlorides and fluorides may be additionally contained as a refining agent for glass melting, as appropriate. The glass in the present invention is essentially made of the foregoing components, but may contain other components in a range that does not interfere with the objects of the present invention. When such other components are contained, the total content of these components is preferably 5% or less, more preferably 3% or less, typically 1% or less. The following describes examples of additional components.

ZrO₂ is not an essential component, but is known to generally increase the surface compressive stress in chemical strengthening. However, containing small amounts of ZrO₂ does not produce large effects, which does not worth the cost. ZrO₂ may thus be contained in a proportion that can be afforded. When ZrO₂ is contained, the content of ZrO₂ is preferably 1% or less.

SrO and BaO are not essential components, but may be contained in small amounts to lower the high-temperature viscosity and devitrification temperature of the glass. SrO or BaO also has the effect to lower the ion-exchange rate. When these are contained, the content of SrO or BaO is preferably 0.5% or less.

ZnO may be contained in at most, for example, 2% to improve high-temperature meltability of glass. It is, however, preferable not to contain ZnO when using a float method, because ZnO is reduced in the float bath, and produces product defects.

B₂O₃ may be contained in less than 1% to improve high-temperature meltability or glass strength. Generally, containing B₂O₃ with the alkali component Na₂O or K₂O causes serious vaporization, and severely corrodes the bricks. It is therefore preferable that t B₂O₃ is not substantially included.

Li₂O is a component that lowers the strain point and facilitates stress relaxation, and works against forming a stable surface compressive stress layer. It is therefore preferable not to contain Li₂O. When it is contained, the content of Li₂O should be preferably less than 1%, more preferably 0.05% or less, particularly preferably less than 0.01%.

The glass of the embodiment generally has a plate shape. However, the glass may be a glass plate subjected to bending work. The glass of the embodiment is a glass plate that has been formed into a plate shape using a conventional glass forming methods such as a float method, a fusion method, and a slot downdraw method.

The glass for chemical strengthening in the invention has dimensions that can be formed using the existing forming methods. Specifically, a continuous ribbon-shaped glass having a float forming width can be obtained using a float method. The glass of the embodiment is finally cut into a size suited for an intended application.

Specifically, the glass is cut into a size of displays for tablet PCs, smartphones or the like, or a size of window glass for building or house. The glass of the embodiment is generally cut into a rectangular shape. However, the glass may have other shapes, for example, such as a circular shape and a polygonal shape, and the case of a drilled glass is included.

There are reports that the glass formed by a float method warps after chemical strengthening, and suffers from poor flatness (for example, Japanese Patent No. 2033034). It is believed that the warping occurs because of the difference in the extent of chemical strengthening at the glass top surface where there is no contact with molten tin, and the glass bottom surface that contacts molten tin during the float forming.

The glass of the embodiment does not undergo large chemical strength characteristics changes even upon contact with molten tin, and does not involve large chemical strength characteristics changes due to changes in water content. The glass of the embodiment can thus exhibit the effect to reduce warping during chemical strengthening, particularly in a float method. The glass of the embodiment thus involves little warping after the chemical strengthening process even when shaped into a thin plate, and has high strength with little warping after the chemical strengthening process.

The glass formed by a float method has different water contents at the top surface and bottom surface because of the moisture vaporization from the top surface. When the proportions of Na₂O, K₂O, and Al₂O₃ are controlled so as to fall in the foregoing ranges, it is possible to reduce warping of the glass after the chemical strengthening due to water content changes.

The glass warping after chemical strengthening also can be effectively reduced by controlling the alkali concentration in the surface layer. Specifically, warping can be reduced by subjecting the top surface of the surface layer to a dealkylation treatment to lower the ion exchangeability at the top surface, and balance the stress that is generated in the top surface after the chemical strengthening with the stress in the bottom surface.

An effective dealkylation technique is to treat the top surface of the surface layer with an acidic gas. The acidic gas may be at least one selected from SO₂ gas, HCl gas and HF gas, or a mixed gas containing at least one acidic gas selected from these. The present inventors found that the increase of the content of Al₂O₃ effectively facilitates dealkylation by SO₂ treatment.

It is believed that increased Al in glass widens the gaps in the glass network structure, and promotes the ion exchange between Na⁺ and H⁺. When the content of Al₂O₃ is 3.4% or more, the dealkylation treatment by SO₂ gas effectively proceeds, and the warping of glass after chemical strengthening can be easily controlled.

In the foregoing equation (2), the thickness t of the glass plate may vary at least 3-fold depending on applications, and it is desirable to specify the thickness of the glass plate for discussing CS and DOL values. The thickness t of the glass plate is preferably 0.1 mm or more, more preferably 0.2 mm or more, further preferably 0.25 mm or more, particularly preferably 0.3 mm or more. The thickness t of the glass plate is generally 3 mm or less, preferably 2 mm or less, more preferably 1.5 mm or less, further preferably 1.3 mm or less, particularly preferably 1.1 mm or less.

When the thickness is 0.1 mm or more, a chemical strengthening process can exhibit a sufficient strength improving effect. A glass plate having a thickness exceeding 3 mm readily allows for a physical strengthening process, and the chemical strengthening process is more required for glass plates having a thickness of 3 mm or less.

For example, in the case of a glass plate having a thickness of 0.7 mm or 1.1 mm, which represents the most preferred thickness of the embodiment, the stress range that makes the glass cuttable and show strength improvement falls in the following ranges. The CS value of the chemically strengthened glass is generally 600 MPa or more, preferably 650 MPa or more. In order to enable cutting after the chemical strengthening process, the CS value is preferably 900 MPa or less, more preferably 850 MPa or less.

The chemically strengthened glass of the embodiment has a DOL value of preferably 5 μm or more, more preferably 7 μm or more. Particularly, the DOL value is preferably 10 μm or more when the glass has the risk of being scratched while being handled. In order to enable cutting after the chemical strengthening process, the DOL value of the chemically strengthened glass is preferably 30 μm or less, more preferably 25 μm or less, further preferably 20 μm or less.

For a thin glass plate, the desirable cuttability can be maintained by controlling the CS and DOL values so as to satisfy the CT value of 30 MPa or less. For example, for a glass plate having a thickness of 0.4 mm, DOL is preferably 12.5 μm or less when CS is 900 MPa, and CS is preferably 600 MPa or less so as to satisfy the DOL of 18 μm. The CT value that enables cutting is preferably 30 MPa or less, more preferably 25 MPa or less.

A thick glass plate may involve a deep scratch in a glass surface depending on the handling way of the glass. The glass surface strength can be improved without sacrificing cuttability by increasing the DOL while maintaining the CT 30 MPa or less. For example, in the case of a glass plate having a thickness of 1.5 mm, the glass can have improved surface strength while maintaining the state being cuttable when the glass has a DOL of 40 μm with a CS value of 900 MPa.

As for the characteristic feature of the glass of the embodiment, it is easily modifiable from a common soda-lime glass in terms of both of manufacture characteristics and product characteristics. The temperature, at which log η=2 which is a measure of high-temperature viscosity in melting glass, is generally 1445 to 1475° C. for a common soda-lime glass. The unit of viscosity η is dPa·s.

When a high-temperature viscosity increase during melting is within about plus 50° C., the glass can easily be produced with a kiln used to melt a common soda-lime glass. With regard to the high-temperature viscosity in melting, the temperature at which a log η=2 is preferably 1520° C. or less, more preferably 1500° C. or less.

The temperature, at which log η=4 which is a measure of high-temperature viscosity in melting glass using a float method, is generally 1020 to 1050° C. for a common soda-lime glass. When a high-temperature viscosity increase at the temperature, at which this viscosity is satisfied, is within about plus 30° C., the glass can easily be produced with a kiln used to form a common soda-lime glass. With regard to the high-temperature viscosity in forming the glass of the embodiment, the temperature at which a log η=4 is preferably 1080° C. or less, more preferably 1060° C. or less.

When the glass is produced using a float method, the risk of devitrification is determined with a devitrification temperature relative to the temperature at which log η=4. Generally, the glass can be produced using a float method without causing devitrification when the glass has a devitrification temperature that is equal to or lower than the temperature at which log η=4 plus 15° C. Preferably, the devitrification temperature is equal to or lower than the temperature at which log η=4.

A common soda-lime glass has a specific gravity of 2.490 to 2.505 at room temperature. Considering that the glass of the embodiment and a common soda-lime glass may be produced in turn using the same kiln, composition changes can easily be attained when the specific gravity changes are 0.03 or less, preferably 0.01 or less. The glass of the embodiment has a specific gravity of preferably 2.480 or more and 2.515 or less.

The effective temperature of the chemical strengthening process can be determined by using the glass strain point as a reference. Generally, a chemical strengthening process is performed at temperatures 50 to 100° C. below the strain point. A common soda-lime glass has a strain point of 490 to 520° C.

Because the glass of the embodiment uses the existing chemical strengthening process, the glass of the embodiment has a strain point of preferably 480 to 540° C., more preferably 490 to 530° C. Because strain point measurement requires a skilled technique, glass transition temperature Tg may be used instead, by determining it through measurement of a coefficient of thermal expansion. Generally, Tg is about 40° C. higher than the strain point. The glass of the embodiment has a Tg of preferably 520 to 580° C., more preferably 530 to 570° C.

A common soda-lime glass has a coefficient of thermal expansion of generally 85×10⁻⁷° C.⁻¹ to 93×10⁻⁷° C.⁻¹ in a temperature range of 50 to 350° C. A glass for a display goes through various processes such as deposition and bonding before it becomes a product for information devices or the like. Here, it is required that the coefficient of thermal expansion does not change greatly from conventional values. The glass of the embodiment has a coefficient of thermal expansion of 83×10⁻⁷° C.⁻¹ to 95×10⁻⁷° C.⁻¹, preferably 85×10⁷° C.⁻¹ to 93×10⁻⁷° C.⁻¹.

The glass of the embodiment can produce a chemically strengthened glass having improved strength by being subjected to the ordinary chemical strengthening process which has been used for a common soda-lime glass. For example, a chemical strengthening process may be performed by immersing the glass of the embodiment in a molten salt of potassium nitrate for 1 to 24 hours at 410 to 470° C.

The glass of the embodiment is cuttable after the chemical strengthening process. The glass may be cut using a common technique with a wheel chip cutter, a scriber, and a breaker. Laser cutting is also possible. After being cut, the glass may be chamfered at the cut edges to maintain glass strength. The chamfering may be performed by using mechanical grinding, or a treatment using a chemical such as hydrofluoric acid.

### EXAMPLES

### Evaluation Method

(1) Specific gravity

Specific gravity was measured according to the Archimedes method.

(2) Coefficient of thermal expansion

Coefficient of thermal expansion was determined as a mean value of coefficient of linear thermal expansion at 50 to 350° C. using TMA

(3) Glass transition point (Tg)

Glass transition point was measured using TMA.

(4) Strain point

Strain point was measured using a fiber elongation method.

(5) High-temperature viscosity

Temperature (T₂) at which a viscosity reaches 10² dPa·s, and temperature (T₄) at which a viscosity reaches 10⁴ dPa·s were measured using a rotary viscometer.

(6) Devitrification temperature (T_{L})

For devitrification temperature measurement, the glass was pulverized into glass particles having a size of about 2-mm by using a mortar, and the glass particles placed side by side on a platinum board were subjected to a heat treatment in a temperature gradient furnace by 5° C. steps for 24 hours. The maximum value of the temperature of the glass particle at which crystal was precipitated was taken as devitrification temperature.

(7) Surface compressive stress (CS) and compressive stress layer depth (DOL)

Surface compressive stress and compressive stress layer depth were measured with a Surface Stress Meter FSM-6000, manufactured by Orihara Manufacturing Co., Ltd. The photoelastic constant and the refractive index used for measurement were obtained by performing regression calculations for prepared compositions (Examples 1 and 2) or an analytical composition (Example 3). The photoelastic constant and the refractive index used in Example 4 are measured values.

(8) Ring-on-ring test

In a ring-on-ring test, a glass sample was cut into a square having each side of 18.5 mm, and sandwiched between a SUS 304 receiver ring and a pressure ring. The sample glass plate horizontally was placed, and pressure was applied to a central portion of the glass plate from above using a pressure jig. The breaking load (unit N) at break was recorded as the surface strength of the glass, and the mean value of 100 measurements was taken as the mean value of the surface strength. The test was performed under the following conditions.

Sample thickness: 0.55 (mm) Descending speed of pressure jig: 1 (mm/min)

(9) Sn amount at bottom surface

X-ray fluorescence analysis was performed for the measurement.

(10) Photoelastic constant

Photoelastic constant was measured according to the circular plate compression method (Measurement of Photoelastic Constant of Glass for Chemical Strengthening by Method of Compression on Circular Plate, Ryosuke Yokota, Journal of Ceramic Society of Japan, 87[10], 1979, p. 519-522).

(11) Refractive index

Refractive index was measured by a spectrometer using a minimum deviation method.

### (12) Warping

Warp was measured using a Flatness Tester FT17V2, manufactured by Nidek.

### Example 1

Common raw glass materials, such as silica sand, soda ash, dolomite, feldspar, salt cake, other oxides, carbonates, and hydroxides were appropriately selected, and weighed to make a composition as represented by the mass percentages based on an oxide shown in Table 1 under the heading “Design”. These were weighed to make the glass 1 kg. The salt cake was supplied in double amount in terms of a SO₃ amount. The weighed raw materials were mixed, and added into a platinum crucible. The crucible was placed in a 1480° C. resistance heating electric furnace, where the materials were melted for 3 hours, degassed, and homogenized.

The molten glass so obtained was flown into a mold, and maintained for 1 hour at a temperature of Tg+50° C. The glass was then allowed to cool to room temperature at a rate of 0.5° C./min to obtain several glass blocks. For samples to be subjected to a chemical strengthening process, the glass blocks were cut and ground, and finally the both surfaces were mirror-finished to obtain a plate-shaped glass having a size of 30 mm×30 mm and a thickness of 1.0 mm.

In Table 1, Examples 1-1 to 1-8 represent working examples. The results of the X-ray fluorescence composition analysis of each glass are shown under the heading “Analysis” in Table 1. Table 1 also presents the specific gravity, coefficient of thermal expansion, Tg, strain point, high-temperature viscosity and devitrification temperature of these glasses. In Table 1, “Calc.” represents values obtained by performing regression calculations for the compositions, and “Mea.” represents the measured values.

The glasses shown in Table 1 were subjected to a chemical strengthening process by immersing each glass in a 435° C. molten salt of potassium nitrate for 200 min in a laboratory. The glass was measured for surface compressive stress CS (unit: MPa) and compressive stress layer depth DOL (unit: μm) after the chemical strengthening process, using a Surface Stress Meter FSM-6000, manufactured by Orihara Manufacturing Co., Ltd. The results of the CS and DOL measurements are shown in corresponding cells in Table 1, along with the photoelastic constant and the refractive index.

A glass melted in a crucible generally has a CS value that is more than 100 MPa higher than the CS values of glasses formed by a float method. A possible reason for this is that a glass melted in an electric furnace has the smaller water content than the cases of glasses melted by burning heavy oil or gas.

Another possible reason for this is that the slower cooling rate of the crucible glass lowers the fictive temperature and increases density, even when the composition is the same. The DOL values are not affected by the glass micro structure, and are essentially the same between the glass melted in a crucible and the glass formed by a float method.

A chemical strengthening process performed in a laboratory generally produces higher CS values than the industrial chemical strengthening process. This is considered to be due to the poor process efficiency of the industrial production attributed to the repeatedly conducted chemical strengthening process that uses the same molten salt, and thus contaminates the molten salt and increases the sodium concentration in the potassium nitrate salt. The potassium nitrate salt used in laboratory has little contamination, and yields high CS values.

TABLE 1

| | | Ex. 1-1 | | Ex. 1-2 | | Ex. 1-3 | | Ex. 1-4 | |
|---|---|---|---|---|---|---|---|---|---|
| | | Design | Analysis | Design | Analysis | Design | Analysis | Design | Analysis |
| (Mass %) | SiO₂ | 68.33 | 68.40 | 68.04 | 67.90 | 68.33 | 68.20 | 68.33 | 68.10 |
| | Al₂O₃ | 5.00 | 5.11 | 4.98 | 5.19 | 5.00 | 5.21 | 5.00 | 5.22 |
| | CaO | 7.00 | 6.95 | 6.97 | 6.98 | 7.47 | 7.49 | 6.91 | 6.93 |
| | MgO | 4.13 | 4.12 | 4.11 | 4.13 | 3.66 | 3.68 | 4.22 | 4.25 |
| | Na₂O | 15.0 | 14.9 | 14.9 | 15.0 | 15.0 | 15.0 | 15.0 | 15.1 |
| | K₂O | 0.12 | 0.17 | 0.55 | 0.57 | 0.12 | 0.17 | 0.12 | 0.17 |
| | TiO₂ | 0.10 | 0.11 | 0.10 | 0.11 | 0.10 | 0.11 | 0.10 | 0.11 |
| | Fe₂O₃ | 0.114 | 0.107 | 0.114 | 0.104 | 0.114 | 0.105 | 0.114 | 0.104 |
| | SO₃ | 0.2 | 0.05 | 0.2 | 0.06 | 0.20 | 0.06 | 0.20 | 0.06 |
| | Total | 100.0 | 99.9 | 100.0 | 100.0 | 100.0 | 100.0 | 100.0 | 100.0 |
| Na₂O/Al₂O₃ | | 3.00 | 2.92 | 3.00 | 2.89 | 3.00 | 2.88 | 3.00 | 2.89 |
| (Na₂O + K₂O)/Al₂O₃ | | 3.02 | 2.95 | 3.11 | 3.00 | 3.02 | 2.91 | 3.02 | 2.93 |
| | | Calc. | Mea. | Calc. | Mea. | Calc. | Mea. | Calc. | Mea. |
| Specific gravity | | 2.5067 | 2.5009 | 2.5078 | 2.5024 | 2.5094 | 2.5041 | 2.5062 | 2.5010 |
| Coefficient of thermal expansion (10⁻⁷° C.⁻¹) | | 91.7 | 92 | 92.8 | 94 | 92.0 | 93 | 91.6 | 92 |
| Glass transition point (° C.) | | — | 556 | — | 554 | — | 557 | — | 557 |
| Strain point (° C.) | | 518 | — | 517 | — | 521 | — | 518 | — |
| T₂ (° C.) | | 1480 | 1455 | 1476 | — | 1478 | — | 1480 | — |
| T₄ (° C.) | | 1045 | 1042 | 1042 | — | 1043 | — | 1045 | — |
| T_{L} (° C.) | | — | 1015 | — | 1005 | — | 1015 | — | 1020 |
| T₄ − T_{L} (° C.) | | — | 27 | — | — | — | — | — | — |
| Photoelastic constant (nmcm/MPa) | | 26.9 | — | 26.8 | — | 26.9 | — | 26.9 | — |
| Refractive index | | 1.5149 | — | 1.5151 | — | 1.5153 | — | 1.5148 | — |
| CS (MPa) | | — | 798 | — | 796 | — | 798 | — | 805 |
| DOL (μm) | | — | 11.15 | — | 11.5 | — | 10.9 | — | 11.1 |
| | | Ex. 1-5 | | Ex. 1-6 | | Ex. 1-7 | | Ex. 1-8 | |
| | | Design | Analysis | Design | Analysis | Design | Analysis | Design | Analysis |
| (Mass %) | SiO₂ | 69.49 | 69.40 | 69.23 | 69.40 | 69.49 | 69.60 | 69.49 | 69.50 |
| | Al₂O₃ | 4.50 | 4.72 | 4.48 | 4.64 | 4.50 | 4.70 | 4.50 | 4.69 |
| | CaO | 7.50 | 7.50 | 7.47 | 7.43 | 8.01 | 7.99 | 7.40 | 7.41 |
| | MgO | 4.49 | 4.54 | 4.47 | 4.47 | 3.98 | 3.99 | 4.59 | 4.60 |
| | Na₂O | 13.5 | 13.5 | 13.4 | 13.2 | 13.5 | 13.3 | 13.5 | 13.4 |
| | K₂O | 0.11 | 0.16 | 0.49 | 0.52 | 0.11 | 0.16 | 0.11 | 0.16 |
| | TiO₂ | 0.10 | 0.10 | 0.10 | 0.10 | 0.10 | 0.11 | 0.10 | 0.10 |
| | Fe₂O₃ | 0.109 | 0.101 | 0.108 | 0.100 | 0.109 | 0.101 | 0.109 | 0.103 |
| | SO₃ | 0.2 | 0.05 | 0.2 | 0.06 | 0.20 | 0.05 | 0.20 | 0.04 |
| | Total | 100.0 | 100.1 | 100.0 | 99.9 | 100.0 | 100.0 | 100.0 | 100.0 |

| Na₂O/Al₂O₃ | 3.00 | 2.86 | 3.00 | 2.84 | 3.00 | 2.83 | 3.00 | 2.86 |
|---|---|---|---|---|---|---|---|---|
| (Na₂O + K₂O)/Al₂O₃ | 3.02 | 2.89 | 3.11 | 2.96 | 3.02 | 2.86 | 3.02 | 2.89 |
| | Calc. | Mea. | Calc. | Mea. | Calc. | Mea. | Calc. | Mea. |
| Specific gravity | 2.5026 | 2.4984 | 2.5036 | 2.4975 | 2.5056 | 2.4998 | 2.5021 | 2.4976 |
| Coefficient of thermal expansion (10⁻⁷° C.⁻¹) | 86.8 | 87 | 87.8 | 88 | 87.2 | 88 | 86.8 | 87 |
| Glass transition point (° C.) | — | 568 | — | 564 | — | 567 | — | 567 |
| Strain point (° C.) | 526 | — | 525 | — | 530 | — | 526 | — |
| T₂ (° C.) | 1492 | 1471 | 1488 | — | 1489 | — | 1492 | — |
| T₄ (° C.) | 1059 | 1058 | 1057 | — | 1057 | — | 1059 | — |
| T_{L} (° C.) | — | 1065 | — | 1060 | — | 1045 | — | 1070 |
| T₄ − T_{L} (° C.) | — | −7 | — | — | — | — | — | — |
| Photoelastic constant (nmcm/MPa) | 27.1 | — | 27.0 | — | 27.0 | — | 27.1 | — |
| Refractive index | 1.3149 | — | 1.5152 | — | 1.5154 | — | 1.5148 | — |
| CS (MPa) | — | 792 | — | 762 | — | 791 | — | 788 |
| DOL (μm) | — | 9.1 | — | 9.2 | — | 9.1 | — | 9.1 |

A 1.1 mm-thick soda-lime glass formed by the float method was subjected to a chemical strengthening process in a laboratory under the same conditions used for the glasses shown in Table 1. The glass typically had a CS of about 600 MPa, and a DOL of about 9 μm. As shown in Table 1, the glasses of Examples 1-1 to 1-4 had higher CS values than the common soda-lime glass, even taking into account that a glass melted in crucible yields high CS values. The DOL values were also about 20% higher. The glasses of Examples 1-5 to 1-8 also had higher CS values than the common soda-lime glass. However, the DOL values were about the same as that of the common soda-lime glass.

It was found that the glasses of Examples 1-1 to 1-8 had CT values in a range of 7.1 to 9.4 MPa as calculated from the CS and DOL values which is a range sufficient for post cutting. The CT value was in a range of 25 to 33 MPa in the case of a glass plate having a thickness of 0.3 mm. However, this range is also sufficient to make the glass substantially cuttable, because float forming yields CS values that are reduced by at least 100 MPa, as described above. For a glass having a thickness thinner than 0.3 mm, the glass would be cuttable when the process time is reduced to make the CT value 30 MPa or less.

### Example 2

Common raw glass materials, such as silica sand, soda ash, dolomite, feldspar, salt cake, other oxides, carbonates, and hydroxides were appropriately selected, and weighed to make a composition as represented by the mass percentages based on an oxide shown in Table 2. These were weighed to make the glass 500 g. The salt cake was supplied in double amount in terms of a SO₃ amount. The weighed raw materials were mixed, and added into a platinum crucible. The crucible was placed in a 1480° C. resistance heating electric furnace, where the materials were melted for 3 hours, degassed, and homogenized.

The molten glass so obtained was flown into a mold and formed into a plate shape having a thickness of about 10 mm, followed by maintaining for 1 hour at 600° C. The glass was then allowed to cool to room temperature at a rate of 1° C./min. For samples to be subjected to a chemical strengthening process, the plate was cut and ground, and finally the both surfaces were mirror-finished to obtain a plate-shaped glass having a size of 50 mm×50 mm and a thickness of 3 mm.

Table 2 presents the specific gravity, coefficient of thermal expansion, strain point and high-temperature viscosity of each glass as determined by regression calculations performed for the composition.

The glasses shown in Table 2 were subjected to a chemical strengthening process by immersing each glass in a 435° C. molten salt of potassium nitrate for 200 min in a laboratory. The glass was measured for surface compressive stress CS (unit: MPa) and compressive stress layer depth DOL (unit: μm) after the chemical strengthening process. The results of the CS and DOL measurements are shown in corresponding cells in Table 2, along with the photoelastic constant and the refractive index.

A glass melted in a crucible generally has a CS value that is higher than the CS values of glasses by at least 100 MPa, the glasses formed by the float method, as mentioned in Example 1. Example 2-1 represents a comparative example in which a common soda-lime glass composition was melted in a crucible for comparison. Examples 2-2 to 2-14 are working examples.

TABLE 2

| | | Ex. 2-1 | Ex. 2-2 | Ex. 2-3 | Ex. 2-4 | Ex. 2-5 | Ex. 2-6 | Ex. 2-7 | Ex. 2-8 |
|---|---|---|---|---|---|---|---|---|---|
| (Mass %) | SiO₂ | 71.760 | 69.230 | 68.197 | 67.165 | 69.924 | 69.378 | 68.831 | 69.378 |
| | Al₂O₃ | 1.81 | 4 | 5 | 6 | 3.5 | 4.0 | 4.5 | 4.0 |
| | CaO | 8.14 | 7.5 | 7.5 | 7.5 | 7.5 | 7.5 | 7.5 | 6.5 |
| | MgO | 4.491 | 4.344 | 3.878 | 3.413 | 4.719 | 4.689 | 4.659 | 5.689 |
| | Na₂O | 13.150 | 14.594 | 15.092 | 15.591 | 13.5 | 13.5 | 13.5 | 13.5 |
| | K₂O | 0.27 | 0 | 0 | 0 | 0.482 | 0.555 | 0.629 | 0.555 |
| | TiO₂ | 0.058 | 0.03 | 0.03 | 0.03 | 0.075 | 0.078 | 0.081 | 0.078 |
| | Fe₂O₃ | 0.101 | 0.1 | 0.1 | 0.1 | 0.10 | 0.10 | 0.10 | 0.10 |
| | SO₃ | 0.22 | 0.202 | 0.202 | 0.202 | 0.20 | 0.20 | 0.20 | 0.20 |
| | Total | 100 | 100 | 100 | 100 | 100.0 | 100.0 | 100.0 | 100.0 |

| Na₂O/Al₂O₃ | 7.27 | 3.65 | 3.02 | 2.60 | 3.86 | 3.38 | 3.00 | 3.38 |
|---|---|---|---|---|---|---|---|---|
| (Na₂O + K₂O)/Al₂O₃ | 7.41 | 3.65 | 3.02 | 2.60 | 3.99 | 3.51 | 3.14 | 3.51 |
| | Calc. | Calc. | Calc. | Calc. | Calc. | Calc. | Calc. | Calc. |
| Specific gravity | 2.4979 | 2.5060 | 2.5104 | 2.5149 | 2.5016 | 2.5040 | 2.5063 | 2.4983 |
| Coefficient of thermal | 86.5 | 90.2 | 91.8 | 93.5 | 88.0 | 88.2 | 88.5 | 87.6 |
| expansion (10⁻⁷° C.⁻¹) | | | | | | | | |
| Strain point (° C.) | 521 | 519 | 521 | 523 | 521 | 522 | 524 | 516 |
| T₂ (° C.) | 1466 | 1470 | 1474 | 1478 | 1476 | 1479 | 1482 | 1482 |
| T₄ (° C.) | 1045 | 1043 | 1042 | 1041 | 1050 | 1052 | 1054 | 1055 |
| Photoelastic constant | 26.9 | 26.8 | 26.8 | 26.8 | 26.9 | 26.9 | 26.9 | 27.0 |
| (nmcm/MPa) | | | | | | | | |
| Refractive index | 1.5143 | 1.5153 | 1.5158 | 1.5163 | 1.5150 | 1.5154 | 1.5159 | 1.5145 |
| | Mea. | Mea. | Mea. | Mea. | Mea. | Mea. | Mea. | Mea. |
| CS (MPa) | 739 | 810 | 806 | 816 | 827 | 812 | 847 | 831 |
| DOL (μm) | 8.7 | 10.1 | 11.1 | 12.0 | 10.0 | 10.3 | 10.5 | 10.3 |

| | | Ex. 2-9 | Ex. 2-10 | Ex. 2-11 | Ex. 2-12 | Ex. 2-13 | Ex. 2-14 |
|---|---|---|---|---|---|---|---|
| (Mass %) | SiO₂ | 69.378 | 69.378 | 70.503 | 70.044 | 70.107 | 69.722 |
| | Al₂O₃ | 4.0 | 4.0 | 4.0 | 4.5 | 4.0 | 4.5 |
| | CaO | 7.319 | 7.0 | 7.2 | 7.0 | 7.0 | 6.8 |
| | MgO | 4.570 | 4.989 | 3.504 | 3.378 | 4.0 | 3.9 |
| | Na₂O | 13.8 | 13.7 | 13.8 | 14.0 | 13.9 | 14.0 |
| | K₂O | 0.555 | 0.555 | 0.628 | 0.710 | 0.628 | 0.710 |
| | TiO₂ | 0.078 | 0.078 | 0.065 | 0.068 | 0.065 | 0.068 |
| | Fe₂O₃ | 0.10 | 0.10 | 0.10 | 0.10 | 0.10 | 0.10 |
| | SO₃ | 0.20 | 0.20 | 0.20 | 0.20 | 0.20 | 0.20 |
| | Total | 100.0 | 100.0 | 100.0 | 100.0 | 100.0 | 100.0 |

| Na₂O/Al₂O₃ | 3.45 | 3.43 | 3.45 | 3.11 | 3.48 | 3.11 |
|---|---|---|---|---|---|---|
| (Na₂O + K₂O)/Al₂O₃ | 3.59 | 3.56 | 3.61 | 3.27 | 3.63 | 3.27 |
| | Calc. | Calc. | Calc. | Calc. | Calc. | Calc. |
| Specific gravity | 2.5029 | 2.5011 | 2.4936 | 2.4941 | 2.4954 | 2.4954 |
| Coefficient of thermal | 89.1 | 88.6 | 88.7 | 89.5 | 89.1 | 89.5 |
| expansion (10⁻⁷° C.⁻¹) | | | | | | |
| Strain point (° C.) | 520 | 518 | 522 | 522 | 519 | 520 |
| T₂ (° C.) | 1478 | 1480 | 1498 | 1502 | 1491 | 1498 |
| T₄ (° C.) | 1050 | 1052 | 1054 | 1056 | 1053 | 1055 |
| Photoelastic constant | 26.9 | 27.0 | 27.2 | 27.2 | 27.1 | 27.1 |
| (nmcm/MPa) | | | | | | |
| Refractive index | 1.5150 | 1.5148 | 1.5124 | 1.5123 | 1.5129 | 1.5128 |
| | Mea. | Mea. | Mea. | Mea. | Mea. | Mea. |
| CS (MPa) | 785 | 805 | 765 | 768 | 774 | 783 |
| DOL (μm) | 10.4 | 10.3 | 11.8 | 13.2 | 11.7 | 12.9 |

As shown in Table 2, the glasses of Examples 2-2 to 2-14 had higher CS values than the glass of Example 2-1, and the DOL values of some of these glasses were about 10% to about 40% higher than that in Example 2-1. The glasses with these CS and DOL values had CT values of 30 MPa or less in the case of a glass plate having a thickness of 0.4 mm or more and 3 mm or less, and the CT range was sufficient for post cutting. For a glass having a thickness thinner than 0.4 mm, the glass would be cuttable when the process time is reduced to make the CT value 30 MPa or less, taking into account the decrease in CS value in float production.

### Example 3

Glass plates of the compositions shown in Table 3 were made with a float kiln. The contents are represented by the mass percentages based on an oxide in Table 3. The composition values shown in the table are values from an X-ray fluorescence analysis. Silica sand, soda ash, dolomite, feldspar, aluminum hydroxide, and salt cake were used as raw glass materials. These were melted by burning natural gas, followed by forming into a 0.55-mm glass ribbon in a float bath. The glass ribbon was cut into a plate shape, and the edge portions were chamfered to obtain a glass substrate having a size of 370 mm×470 mm (Example 3-2). Example 3-2 is a working example.

The glass of Example 3-1 is a common soda-lime glass tested for comparison, and represents a comparative example. The common glass was also formed in 0.55 mm, and prepared into a glass substrate having a size of 370 mm×470 mm, as above.

Table 3 presents the specific gravity, coefficient of thermal expansion, Tg, strain point, high-temperature viscosity and devitrification temperature of these glasses. In Table 3, “Calc.” represents values obtained by performing regression calculations for the compositions, and “Mea.” represents the measured values.

The glass substrates so made were subjected to a chemical strengthening process by immersing each glass substrate in a 435° C. molten salt of potassium nitrate for 140 min, using an industrially used chemical strengthening tank. 100 samples of each glass were measured for surface compressive stress CS (unit: MPa) and compressive stress layer depth DOL (unit: μm) after the chemical strengthening process, using a Surface Stress Meter FSM-6000, manufactured by Orihara Manufacturing Co., Ltd. The photoelastic constant, the refractive index, and the mean values of CS and DOL, the standard deviations of CS and DOL, the maximum values of CS and DOL and the minimum values of CS and DOL are presented in corresponding cells under the heading “Float” in Table 3.

The surface strength of these glasses was measured by conducting a ring-on-ring test. The mean value, standard deviation, maximum value and minimum value of surface strength are presented in corresponding cells in Table 3.

For comparison, two glasses were made in a crucible using the methods described in Example 2, and subjected to a chemical strengthening process under the conditions described in Example 2. The CS and DOL values after the chemical strengthening are given under the heading “Lab.” in Table 3.

TABLE 3

| | | Ex. 3-1 | | Ex. 3-2 | |
|---|---|---|---|---|---|
| | | Analysis | | Analysis | |
| (Mass %) | SiO₂ | 71.760 | | 70.970 | |
| | Al₂O₃ | 1.81 | | 3.6 | |
| | CaO | 8.14 | | 7.25 | |
| | MgO | 4.491 | | 4.840 | |
| | Na₂O | 13.150 | | 13.090 | |
| | K₂O | 0.27 | | 0.05 | |
| | TiO₂ | 0.058 | | 0.024 | |
| | Fe₂O₃ | 0.101 | | 0.008 | |
| | SO₃ | 0.22 | | 0.15 | |
| | Total | 100 | | 100.002 | |
| Na₂O/Al₂O₃ | | 7.27 | | 3.62 | |
| (Na₂O + K₂O)/Al₂O₃ | | 7.41 | | 3.63 | |
| | | Calc. | Mea. | Calc. | Mea. |
| Specific gravity | | 2.4937 | 2.4927 | 2.4912 | 2.4883 |
| Coefficient of thermal | | 86.8 | 88 | 85.0 | 85 |
| expansion (10⁻⁷° C.⁻¹) | | | | | |
| Glass transition | | — | 557 | — | 567 |
| point (° C.) | | | | | |
| Strain point (° C.) | | 519 | — | 524 | — |
| T₂ (° C.) | | 1468 | — | 1495 | — |
| T₄ (° C.) | | 1045 | — | 1062 | — |
| T_{L} (° C.) | | — | 1030 | — | — |
| | | Float | Lab. | Float | Lab. |
| Photoelastic | | 26.9 | — | 27.2 | — |
| constant (nmcm/MPa) | | | | | |
| Refractive index | | 1.5143 | — | 1.5135 | — |
| Surface | Mean (N) | 383 | — | 626 | — |
| strength | Standard | 148 | — | 291 | — |
| | deviation (N) | | | | |
| | Maximum | 793 | — | 1528 | — |
| | value (N) | | | | |
| | Minimum | 100 | — | 195 | — |
| | value (N) | | | | |
| CS | Mean (MPa) | 544 | 739 | 632 | 771 |
| | Standard | 38.5 | — | 22.4 | — |
| | deviation | | | | |
| | (MPa) | | | | |
| | Maximum | 636 | — | 674 | — |
| | value (MPa) | | | | |
| | Minimum | 438 | — | 589 | — |
| | value (MPa) | | | | |
| DOL | Mean (μm) | 8.9 | 8.7 | 10.4 | 8.8 |
| | Standard | 0.1 | — | 0.1 | — |
| | deviation | | | | |
| | (μm) | | | | |
| | Maximum | 9.3 | — | 10.5 | — |
| | value (μm) | | | | |
| | Minimum | 8.7 | — | 10.1 | — |
| | value (μm) | | | | |

As shown in Table 3, the glass of Example 3-2 had the higher strength than the case of the glass of Example 3-1. The glass of Example 3-2 was cut with a wheel cutter after the chemical strengthening, and it was confirmed that the glass was sufficiently cuttable.

As shown in Table 3, the difference in CS values was about 200 MPa in Example 3-1, whereas the CS difference was reduced to 70% in Example 3-2. This is considered to be due to the glass of Example 3-2 being more resistant to the effect of tin entry, dealkylation of surface layer or water content changes. The degree of warping after the chemical strengthening was smaller in Example 3-2 than the case in Example 3-1.

### Example 4

Glass plates of the compositions shown in Table 4 were made with a float kiln. The contents are represented by the mass percentages based on an oxide in Table 4. The composition values shown in the table are values from an X-ray fluorescence analysis. Silica sand, soda ash, dolomite, feldspar, and salt cake were used as raw glass materials. These were melted by burning natural gas, followed by forming into glass ribbons having a thickness of 0.7 mm or 5 mm in a float bath.

Example 4-2 represents the glass in the present invention. The glass of Example 4-1 is a common soda-lime glass tested for comparison. The common glass was also formed into glass ribbons having a thickness of 0.7 mm or 5 mm. The Sn amounts at the bottom surface are values obtained by analyzing the glass plate having a thickness of 0.7 mm.

Table 4 presents the specific gravity, coefficient of thermal expansion, Tg, strain point, high-temperature viscosity, devitrification temperature, photoelastic constant and refractive index of these glasses. In Table 4, “Calc.” represents values obtained by performing regression calculations for the compositions, and “Mea.” represents the measured values. Measurements were made for glass samples cut from the glass having a thickness of 5 mm.

The glass plate having a thickness of 0.7 mm was cut into several plates having each side of 50 mm, followed by subjecting to a chemical strengthening process by immersing in a 450° C. molten salt of potassium nitrate for 60 min to 240 min. Each glass was measured for surface compressive stress CS (unit: MPa) and compressive stress layer depth DOL (unit: μm) after the chemical strengthening process, using a Surface Stress Meter FSM-6000, manufactured by Orihara Manufacturing Co., Ltd. The flatness of the plate having each side of 50 mm was measured, and the difference between the maximum value and minimum value of the measured heights was calculated as a warp value (unit: μm). Table 5 presents the CS, DOL and warp.

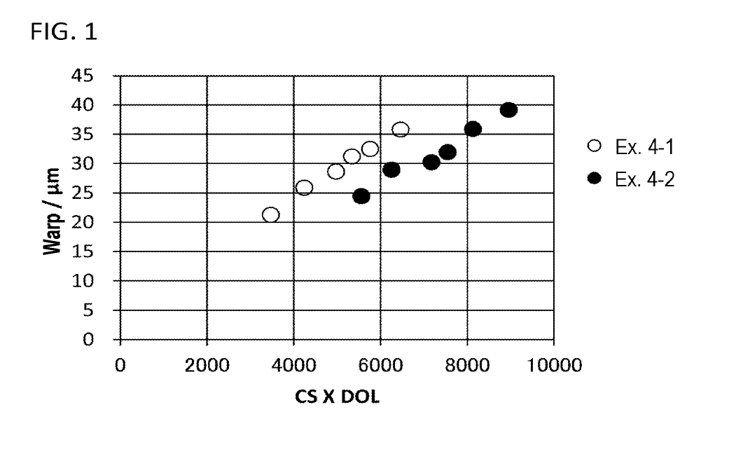

As shown in Table 5, Example 4-2 had higher CS and DOL values than Example 4-1 after the chemical strengthening process performed under the same condition. However, the warping after the chemical strengthening was dependent on the generated stress in the surface layer, specifically the CS×DOL unbalance. FIG. 1 represents the relationship between CS×DOL and warping. As can be seen in FIG. 1, the warp against CS×DOL is smaller in the glass of Example 4-2 than the case in the glass of Example 4-1. Specifically, the glass in the present invention is less likely to warp than a common soda-lime glass under a given stress, provided that the chemical strengthening process is the same.

TABLE 4

| | | Ex. 4-1 | Ex. 4-2 |
|---|---|---|---|
| | | Analysis | Analysis |
| (Mass %) | SiO₂ | 72.00 | 68.40 |
| | Al₂O₃ | 1.86 | 4.95 |
| | CaO | 7.82 | 7.25 |
| | MgO | 4.69 | 4.10 |
| | Na₂O | 13.0 | 14.6 |
| | K₂O | 0.31 | 0.20 |
| | TiO₂ | 0.07 | 0.13 |
| | Fe₂O₃ | 0.104 | 0.116 |
| | SO₃ | 0.19 | 0.26 |
| | Total | 100.04 | 100.01 |

| Na₂O/Al₂O₃ | 6.99 | | 2.95 | |
|---|---|---|---|---|
| (Na₂O + K₂O)/Al₂O₃ | 7.16 | | 2.99 | |
| Sn amount at bottom | 6.4 | | 4.6 | |
| surface 0.7 mm | | | | |
| (μg/cm²) | | | | |
| | Calc. | Mea. | Calc. | Mea. |
| Specific gravity | 2.4921 | 2.4945 | 2.4881 | 2.5019 |
| Coefficient of thermal | 85.9 | 88 | 90.7 | 91 |
| expansion (10⁻⁷° C.⁻¹) | | | | |
| Glass transition | — | 553 | — | 552 |
| point (° C.) | | | | |
| Strain point (° C.) | 520 | 511 | 521 | 512 |
| T₂ (° C.) | 1472 | 1471 | 1482 | 1473 |
| T₄ (° C.) | 1048 | 1039 | 1048 | 1042 |
| T_{L} (° C.) | — | 1020 | — | 1025 |
| Photoelastic | 27.0 | 27.1 | 26.9 | 27.1 |
| constant (nmcm/MPa) | | | | |
| Refractive index | 1.514 | 1.518 | 1.515 | 1.518 |

TABLE 5

| | Ex. 4-1 | | | | Ex. 4-2 | | | |
|---|---|---|---|---|---|---|---|---|
| Time | CS | DOL | CS × | Warp | CS | DOL | CS × | Warp |
| (min) | (MPa) | (μm) | DOL | (μm) | (MPa) | (μm) | DOL | (μm) |
| 60 | 551 | 6.3 | 3471 | 21 | 639 | 8.7 | 5559 | 24 |
| 90 | 544 | 7.8 | 4243 | 26 | 626 | 10.0 | 6255 | 29 |
| 120 | 535 | 9.3 | 4976 | 29 | 611 | 11.8 | 7173 | 30 |
| 150 | 529 | 10.1 | 5343 | 31 | 595 | 12.7 | 7550 | 32 |
| 180 | 519 | 11.1 | 5761 | 33 | 583 | 14.0 | 8133 | 36 |
| 240 | 509 | 12.7 | 6464 | 36 | 565 | 15.9 | 8955 | 39 |

While the invention has been described in detail and with reference to specific embodiments thereof, it will be apparent to one skilled in the art that various changes and modifications can be made therein without departing from the spirit and scope thereof.

This application is based on Japanese Patent Application No. 2013-119906 filed on Jun. 6, 2013, and Japanese Patent Application No. 2013-258469 filed on Dec. 13, 2013, the entire contents of which are hereby incorporated by reference.

### INDUSTRIAL APPLICABILITY

The chemically strengthened glass in the present invention obtained after a chemical strengthening process of the glass for chemical strengthening in the present invention can be used as a cover glass of display devices, particularly touch panel displays and the like. The chemically strengthened glass in the present invention can be also used for double-glazing glass for buildings and houses, solar cell substrates and the like.

1. A glass for chemical strengthening, which is a glass plate comprising, as represented by mass percentage based on the following oxides, 65 to 72% of SiO₂, 3.4 to 8.6% of Al₂O₃, 3.3 to 6% of MgO, 6.5 to 9% of CaO, 13 to 16% of Na₂O, 0 to 1% of K₂O, 0 to 0.2% of TiO₂, 0.01 to 0.15% of Fe₂O₃ and 0.02 to 0.4% of SO₃, wherein (Na₂O+K₂O)/Al₂O₃ is 1.8 to 5.

2. The glass for chemical strengthening according to claim 1, wherein the glass plate has a thickness of 0.1 mm or more and 1.5 mm or less.

3. The glass for chemical strengthening according to claim 1, which comprises, as represented by mass percentage based on the following oxides, 0 to 0.5% of SrO, 0 to 0.5% of BaO and 0 to 1% of ZrO₂, and does not substantially comprise B₂O₃.

4. The glass for chemical strengthening according to claim 1, wherein the glass plate is formed by a float method.

5. A chemically strengthened glass obtained by conducting a chemical strengthening process of the glass for chemical strengthening as described in claim 1.

6. The chemically strengthened glass according to claim 5, which has a surface compressive stress (CS) of 600 MPa or more, a compressive stress layer depth (DOL) of 5 μm or more and 30 μm or less, and a center tensile stress (CT) of 30 MPa or less,
wherein the center tensile stress (CT) is calculated according to the following formula (1):
CT=CS·DOL/(t−2DOL) (1),
where t is a thickness of the glass plate.

7. The chemically strengthened glass according to claim 6, wherein the surface compressive stress is 650 MPa or more, and the compressive stress layer depth is 7 μm or more and 20 μm or less.

8. A method for producing a chemically strengthened glass,
the method comprising a chemical strengthening step of subjecting the glass for chemical strengthening as described in claim 1 to an ion exchange process.

9. The method according to claim 8, wherein:
the glass for chemical strengthening is formed by a float method, and has a bottom surface to contact with a molten metal during forming, and a top surface opposite the bottom surface, and
the method comprises a step of subjecting the top surface to a dealkylation treatment with an acidic gas before the chemical strengthening step.
